(19) United States
(12) Patent Application Publication
(10) Pub. No.: US 2013/0041778 A1
(43) Pub. Date: Feb. 14, 2013

(54) METHOD AND SYSTEM FOR IMPROVING A PRODUCT RECOMMENDATION MADE FOR MATCHING A CONSUMER WISH LIST

(71) Applicants: Alon NATIV, Yahud (IL); Oren Bajayo, Tel-Aviv (IL); Saar Wilf, Tel-Aviv (IL)

(72) Inventors: Alon NATIV, Yahud (IL); Oren Bajayo, Tel-Aviv (IL); Saar Wilf, Tel-Aviv (IL)

(73) Assignee: The Owl Wizard Ltd., Tel-Aviv (IL)

(21) Appl. No.: 13/572,748

(22) Filed: Aug. 13, 2012

Related U.S. Application Data
(60) Provisional application No. 61/523,338, filed on Aug. 13, 2011.

(51) Int. Cl. G06Q 30/00

(52) U.S. Cl. 705/26.62

(57) ABSTRACT

A computer-implemented method and system for automatically improving the matched products recommended to a potential buyer by helping the buyer refine his answers to a product discovery questionnaire. One method comprises of processing the consumer's answers to an interactive product discovery questionnaire, identifying answer constraints, searching for reasonable alternative answers and offering them back to the consumer as a questionnaire refinement option. Another method comprises of allowing the buyer to visually navigate different tradeoff axes while viewing newly matched products in real-time during navigation. Accepting these optional refinements will yield superior, better matching products to the consumer, increasing his satisfaction with the product and service, and increasing the conversion rates and ultimately the revenues of the shopping service.

### CROSS REFERENCE TO RELATED APPLICATIONS

The present application claims the priority rights of U.S. provisional patent application No. 61/523,338, entitled “A COMPUTER-IMPLEMENTED METHOD AND SYSTEM FOR AUTOMATICALLY IMPROVING THE MATCHED PRODUCTS RECOMMENDED TO A POTENTIAL BUYER” filed in Aug. 13, 2011 by Saar Wilf, one of the present inventors.

### COPYRIGHT NOTICE

A portion of the disclosure of this patent document contains material, which is subject to copyright protection. The copyright owner has no objection to facsimile reproduction of the patent document or the patent disclosure, as it appears in the Patent and Trademark Office patent files or records, but otherwise reserves all copyright rights whatsoever.

### BACKGROUND OF THE INVENTION

1. Field of the Invention

The present invention is directed to computer networks, and more particularly to a method and system for automatically improving the matched product list recommended to a potential buyer.

2. Description of Related Art

In the process of online shopping, consumers purchase products or services over the Internet. An online shop embodies the physical analogy of buying products or services at a bricks-and-mortar retailer or in a shopping mall.

Online shoppers enjoy a wider choice of merchandise from the comfort of their living room. Online shops are usually open 24 hours a day, 7 days a week and simplify the purchase order to merely a click of a button. The online shops usually offer a much wider product selection than their counterpart brick and mortar shops while providing greater freedom and control.

Online shopping is a large and still growing market. Electronic commerce product sales totaled $146.4 billion in the United States in 2006, representing about 6% of retail product sales in the country.

At online shops, consumers find a product of interest by visiting the website of the retailer directly, or do a search across many different vendors using a shopping search engine. One of the major obstacles facing consumers that wish to shop online is the lack of a human salesman needed to act as a guide through the exploratory section of the purchase process. With such a huge variety of products to choose from online, and without an intelligent guide, the consumer faces a daunting task of understanding what product is best suited for his own personal needs.

In recent years, online shops have been continually improving their product discovery process. So much in fact, that Forrester Research has tagged “discovery search” as a hot trend for 2007. With discovery shopping, the online shop emphasizes the browsing aspects of the shopping experience. Discovery shopping search offers shoppers guided queries for more personalized results. To achieve this experience online, discovery shopping sites offer features such as specifying styles, colors and brands, showing similar items, and displaying results in a visually engaging format. Such tools allow shoppers to narrow down the large number of potential products to a manageable set of appealing products.

Today, at some online shops, a consumer can answer an interactive product discovery questionnaire and detail his personal needs from the product in question. The online shop in turn, shows a list of matching products. But even with all these advances in product exploration, a common problem continues to persist. Without the guide of a human expert, the consumer often expresses a set of requirements that might yield excessive constraints from the products in question. For example, when purchasing a television, a consumer might request that the TV set is priced under $500, has a larger than 50″ display and weighs less than 30 lb. This consumer does not know that such a TV might not exist, and faces a “no results found” screen. The consumer does not know which of the many constraints included in the requirements is the culprit. It might even be a combination of multiple constraints that working together causes the problem. An even more problematic example is when the shopping site actually has a couple of TV sets that fit these excessive constraints. At first glance, this might not seem problematic. The shopping site found exactly what the consumer wanted. But the consumer might have agreed to pay $50 more if he had known that a much better TV set would then be applicable to his request. Buying that better TV set is a preferred option from the viewpoints of both the shopper and the shopping site. Most shopping sites, fully focused on the consumer's excessive constraints, will not identify this possibility and would not show this option to the consumer.

Current shopping sites perform poorly in such conditions, as they fail to identify that a constraint given by the user might be a more flexible constraint than others. While an experienced human seller can identify such an opportunity and suggest more flexibility for a much better product match, current shopping sites usually continue to show only the products that fit the given strict requirement or constraints.

It is provided a solution to the issues described by a system that helps improve the matched products recommended to a consumer, helping the consumer to refine answers to a product discovery questionnaire.

### BRIEF SUMMARY OF THE INVENTION

It is provided according to certain preferred embodiments of the preset application, a computer-implemented method for suggesting an inventory of several matched products to a potential buyer of a product after getting a certain answer set provided by the buyer in a response to a respective product discovery questionnaire. The method includes identifying an answer different from the respective answer in the certain answer set. The different answer and the respective answer are both possible answers to the same question in the certain product discovery questionnaire. The method further includes a step of presenting to the buyer input requests associated with the different answer, defining a refined answer set in accordance with the input provided by the buyer in response to the input request, and preparing a refined inventory of matched products in accordance with the refined answer set. The refined answer set includes the different answer. Consequently, the refined inventory is presented to the buyer to facilitate placement of an order for a product of the refined inventory.

In some embodiments, the different answer is identified as having a chance to be acceptable by the buyer.

In some embodiments, the method includes a step of not requesting a buyer to respond to a product discovery questionnaire in addition to the product discovery questionnaire the buyer had already responded to.

In some embodiments, the method includes a step of selecting a different answer from a group of different answers consisting of a different answer to a single choice question, a different answer to a multiple choice question, a different answer to a numeric value question and a different answer to a number range question.

In some embodiments, the method includes a step of presenting an inventory of one or more matched products compatible with an answer set.

In some embodiments, further includes a step of displaying an explanation in association with presenting an inventory of several matched products compatible with a refined answer set. The explanation includes items like an identification of an answer in the refined answer set different from a respective answer in the certain answer set, and a description of the improvement done in moving from the certain inventory to the refined answer set.

In some embodiments, the method includes calculating a matching score for each product of a product inventory, and displaying the matching score in association with the respective product. The matching score reflecting the compatibility of the product with the answer set.

In some embodiments, a refined inventory of matched products includes at least one product having a higher matching score than any of the products of a product inventory associated with the certain answer set.

In some embodiments, the matching score is calculated in accordance with a set of matching rules. An exemplary matching rule is a filter rule determining whether a product is accepted or rejected. Another exemplary matching rule is a numeric value rule contributing a calculated numeric value to the product matching score in accordance with the extent a product matches answers of the answer set.

In some embodiments, the method includes preparing two refined inventories of matched products in accordance with respective refined answer sets, and calculating two respective inventory matching scores for the two or more respective refined answer sets. Each inventory matching score is a normalized sum of matching scores of at least a fixed top relative part of the matching products in the inventory. The method further includes presenting the inventories and the associated inventory matching scores to the buyer.

In some embodiments, certain steps of the method are repeated with a refined answer set serving as a certain answer set or a basis answer set. Preferably, the repeating continues until a placement of an order for the product occurs, or the system implementing the method finds out, that no better refined answer set is available.

In some embodiments, the method includes a step of presenting the buyer a certain product discovery questionnaire comprising a plurality of questions, and presenting for each question of at least a major portion of the plurality of questions one or more possible answers such as to allow the buyer to provide the certain answer set. Exemplary questions include a question requiring a single choice answer, a question allowing multiple choice answers, a question requiring a numeric value answer, a question requiring a numeric range answer, and a question requiring a free text answer.

It is provided according to certain preferred embodiments of the present patent application, a computer-implemented method for suggesting an inventory of several matched products to a potential buyer of a product after getting a certain answer set provided by the buyer in a response to a product discovery questionnaire. The method includes identifying a trade off situation between at least two parameters, a first parameter of the product and a second parameter of the product, such that an increase in one parameter of the product occurs together with a decrease of the at least one other parameter of the product, presenting a visual display showing the trade off situation between the two parameters, and providing an inventory of several matched products associated with a refined answer set compatible with the indicated preference. The visual display includes an indicating means for allowing the buyer to indicate a preference of one parameter relative to the other parameter.

In some embodiments, the method includes a step of calculating a first difference and a second difference associated respectively with the first parameter and the second parameter. A parameter difference is between a parameter value attributed to the refined answer set and a parameter value attributed to the certain answer set. Preferably, the method further includes a step of presenting the first difference and the second difference, thus facilitating a quantitative analysis of the tradeoff situation.

In some embodiments, exemplary parameters includes a parameter determined by an analysis of an answer set, a price of the product, a matching score reflecting the matching of a product to at least a portion of an associated answer set, a number of matching products in an inventory of matched products compatible with an associated answer set, a sum of matching scores of at least a fixed top relative part of the matching products in an inventory of matched products compatible with an associated answer set, and a normalized sum thereof.

In some embodiments, the method further includes a step of presenting an updated inventory of several matched products simultaneously with determining a preference indication by the buyer.

In some embodiments, the indicating means is an indicator free to move along a segment. The method includes causing the indicator to jump in a direction determined by the buyer in accordance with the availability of inventories compatible with the indicated preference, and disabling indicator movement in a direction once no products are available in that direction.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1 illustrates a system for improving the matched products recommended to a potential buyer by helping the buyer refine answers to a product discovery questionnaire.

FIG. 2 illustrates the components of the system and its internal data flow.

FIG. 3 illustrates an example of different question types appearing in a product discovery questionnaire.

FIG. 4a illustrates an example of an alternative answer suggested to a buyer, and an inventory of suggested products having a matching score.

FIG. 4b presents the question in FIG. 4a as an enlarged inset.

FIG. 4c presents a visual display for pictorial display of a tradeoff situation.

FIGS. 5a, 5b,5c,5d include tables of answer sets and the respective scores.

FIG. 6 is a flow chart of a method for suggesting a product inventory to a buyer.

FIG. 7 is a flow chart of a method for suggesting a product inventory to a buyer under a tradeoff situation.

### DETAILED DESCRIPTION OF ILLUSTRATIVE EMBODIMENTS

The present invention will now be described in terms of specific example embodiments. It is to be understood that the invention is not limited to the example embodiments disclosed. It should also be understood that not every feature of the methods and systems handling the described device is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

The present invention will now be described in detail with reference to the drawings, which are provided as illustrative examples of the invention so as to enable those skilled in the relevant art(s) to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The disclosed system processes answers of a consumer to an interactive product discovery questionnaire, identifies the constraints, searches for reasonable alternative answers and offers them back to the consumer as a refined questionnaire. Accepting the offered refinement yields products matching better the consumer's needs, thus increasing his satisfaction with the product and service, and increasing the conversion rates and ultimately the revenues of the shopping service. For example, a buyer might answer the questionnaire with a selected price limit at $1000, while a $1050 product exists that is a far better match to the buyer's needs. In such a case, the system might suggest to increase the price limit by $50 and thus offer a much better product.

The disclosed system avoids showing alternative answer sets that the buyer rejected previously, and also avoids suggesting changed answers that were already suggested.

In addition, the system allows a buyer to analyze tradeoff constraints. Before describing that option in detail, two relevant terms are explained by a way of example, a constraint and a constraint parameter. A common constraint is the price of the product. Possible prices may be arranged along a price constraint axis in a linear increasing value, between $100 and $1000 for example. A shopper or buyer may select a maximal price value of $250 as a constraint parameter, and thus the shopper addresses a specific point indicating $250 along the price axis fitting the corresponding price constraint parameter.

For analyzing a trade off situation, two or more constraints are taken into account. In the case of two constraints, the situation is defined by two perpendicular axes representing the two respective constraints over a two dimensional map. In an exemplary trade off situation of price versus a certain benefit, each available product may be represented by a point on the map having a cost coordinate and a benefit coordinate respectively fitting the price value and the benefit value of the product. A point having a higher cost and lower benefit than another point may be ignored as it offers no value to the buyer. A line connecting the remaining points is therefore a monotonic line, expressing the cost/benefit trade off. The system allows the buyer to navigate between the points along that line and pictorially see how a change in price affects the corresponding benefit value. In one embodiment the system presents multiple products per price point. In another embodiment, the system presents only the best matched product.

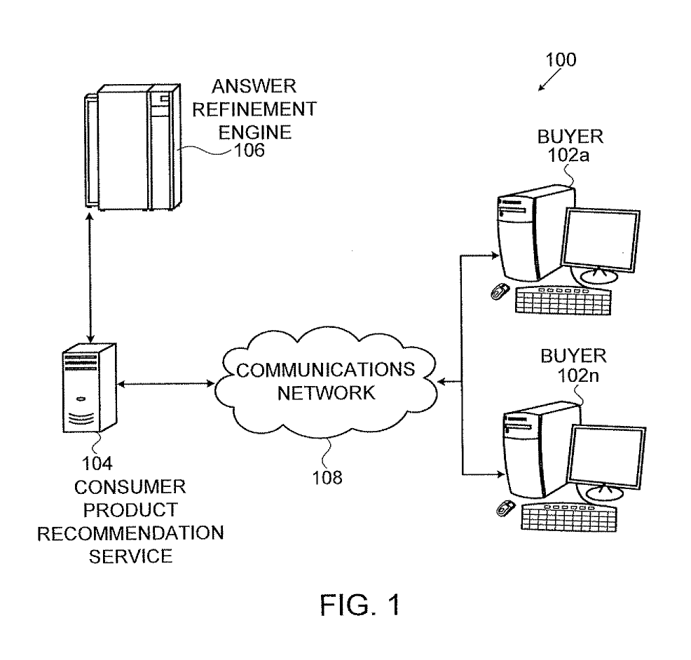

FIG. 1 illustrates one embodiment of a system 100 for automatically improving the matched products recommended to a potential buyer by helping the buyer refine his answers to a product discovery questionnaire. A plurality of buyers 102a-102n are connected via a communication network, the Internet for example, to a Consumer Product Recommendation Service 104 to get a recommendation regarding products they would like to buy. An Answer Refinement Engine 106 helps a buyer 102a to refine her answers to the product discovery questionnaire such as to get improved product recommendation.

As explained in greater detail below, the Consumer Product Recommendation Service 104 urges a buyer 102a to fill in a product discovery questionnaire and thus provide an initial answer set. Then, service 104 finds out the products that best match the buyers based on the initial answer set. The Answer Refinement Engine 106 processes the filled product discovery questionnaire, identifies possible refinements to the questionnaire and offers them back to the buyer 102a through the Consumer Product Recommendation Service 104 such as to identify a possible refined answer set, and presents to buyer 102a a question or another mechanism to affect the refined answer set. Consequently, the buyer decides whether to accept the suggested refinements and get better matched products. An associated inventory of suggested products and matching scores may be presented during that process to help the buyer to get a decision regarding the refinements of the answer set and the desired product.

A Consumer Product Recommendation Service 104 and an Answer Refinement Engine 106 can be implemented via one or more servers, with each server being one or more computers providing various shared resources with each other and to other system components. The shared resources include files for programs, web pages, databases and libraries, output devices such as printers, plotters, display monitors and facsimile machines, communications devices, such as modems and Internet access facilities, and other peripherals such as scanners. The communications devices can support wired or wireless communications, including satellite, terrestrial (fiber optic, copper, coaxial, and the like), radio, microwave, free-space optics, and/or any other form or method of transmission.

The server hosting a Consumer Product Recommendation Service 104 and an Answer Refinement Engine 106 may be configured to support the standard Internet Protocol (IP) developed to govern communications over public and private Internet backbones. The protocol is defined in Internet Standard (STD) 5, Request for Comments (RFC) 791 (Internet Architecture Board). The server also supports transport protocols, such as, Transmission Control Protocol (TCP), User Datagram Protocol (UDP), Real Time Transport Protocol (RIP), or Resource Reservation Protocol (RSVP). The transport protocols support various types of data transmission standards, such as File Transfer Protocol (FTP), Hypertext Transfer Protocol (HTTP), Simple Network Management Protocol (SNMP), Network Time Protocol (NTP), or the like.

Communications network 108 provides a transmission medium for communicating among the system components. Communications network 108 includes a wired and/or wireless local area network (LAN), wide area network (WAN), or metropolitan area network (MAN), such as an organization's intranet, a local internet, the global-based Internet, including the World Wide Web (WWW)), an extranet, a virtual private network, licensed wireless telecommunications spectrum for digital cell (including CDMA, TDMA, GSM, EDGE, GPRS, CDMA2000, WCDMA FDD and/or TDD or TD-SCDMA technologies), or the like. Communications network 112 includes wired, wireless, or both transmission media, including satellite, terrestrial (e.g., fiber optic, copper, UTP, STP, coaxial, hybrid fiber-coaxial (HFC), or the like), radio, free-space optics, microwave, and/or any other form or method of transmission.

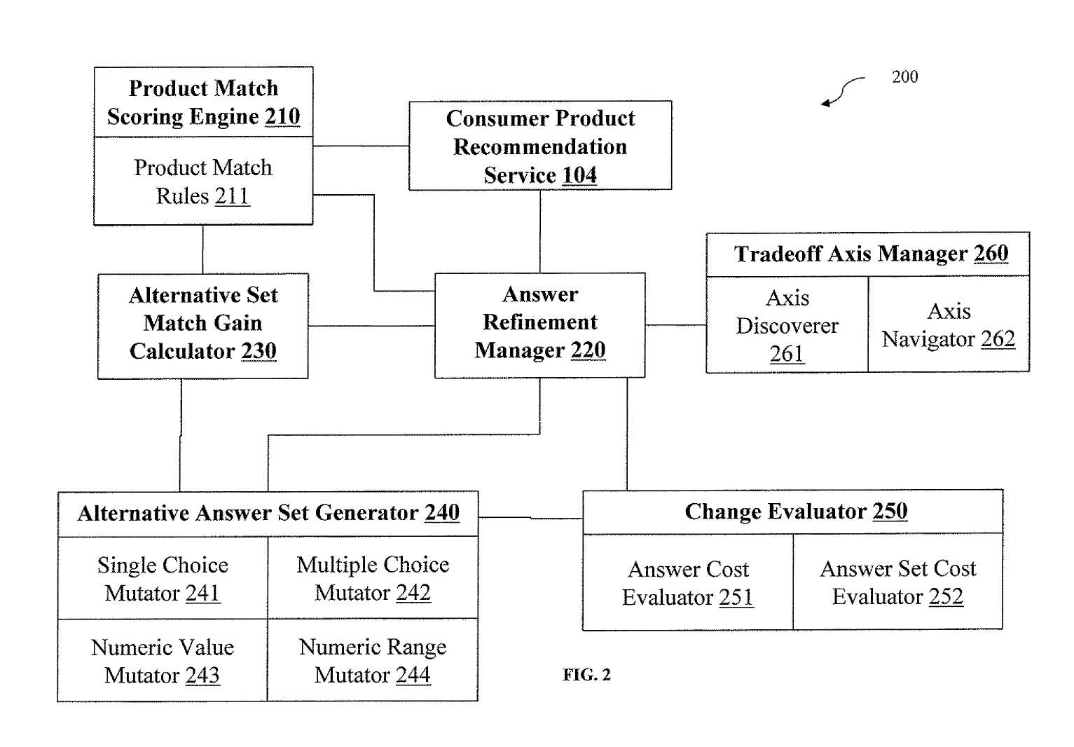

FIG. 2 illustrates system 200, showing components and internal data flow. The components of FIG. 2 can be implemented using a combination of computer hardware, firmware, and software, using engineering design techniques and network protocols that are guided by the principles of the present invention as would become apparent from the detailed descriptions herein. For example, all components can be implemented as software components running on top of standard personal computers running the Linux operating systems. System 200 includes Consumer Product Recommendation Service 104, an Answer Refinement Manager 220, an Alternative Set Match Gain Calculator 230, an Alternative Answer Set Generator 240, a Change Evaluator 250 and a Tradeoff Axis Manager 260. A Product Match Scoring Engine 210 may be internal to the Answer Refinement Engine or external, i.e., as part of the Consumer Product Recommendation Service 104.

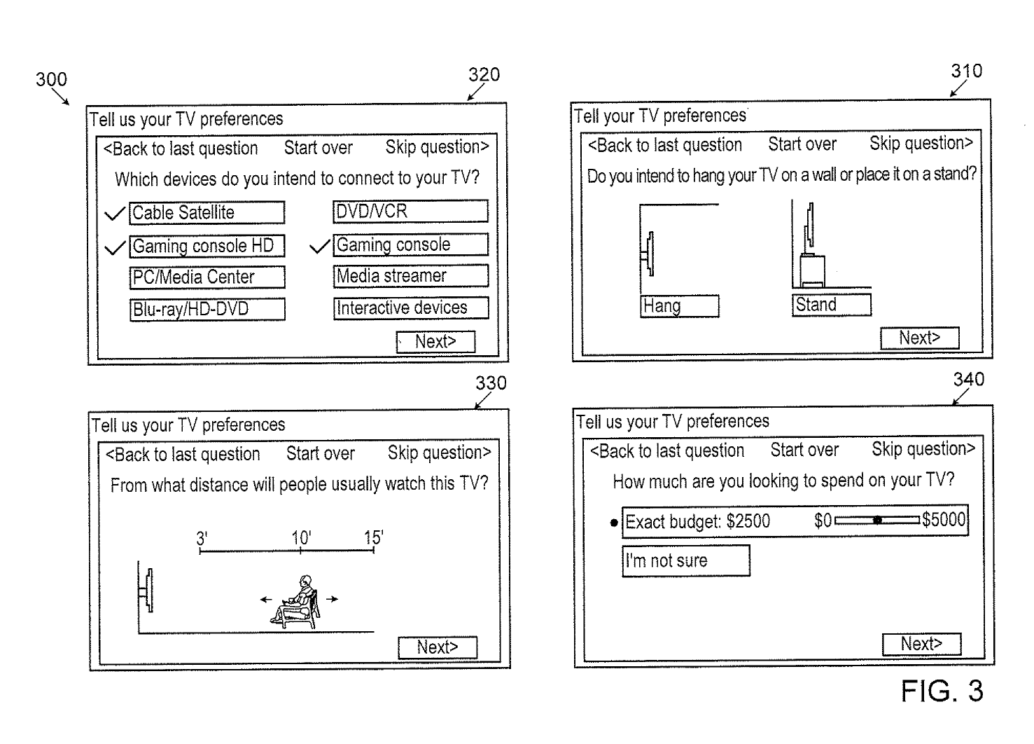

FIG. 3 illustrates an example of a Product Discovery Questionnaire screen 300 using a user interface and graphical presentation for presenting a list of questions for clarifying the needs and wishes of the consumer. The list of questions includes a single choice answer 310, a multiple choice answer 320, and questions 330 and 340 requiring a numeric value answer within predetermined bounds. In addition, a question may be a combination of questions of the above types. The replies of the consumer to those questions constitute an initial answer set, which is actually a set of parameters characterizing the product that the consumer would like to purchase.

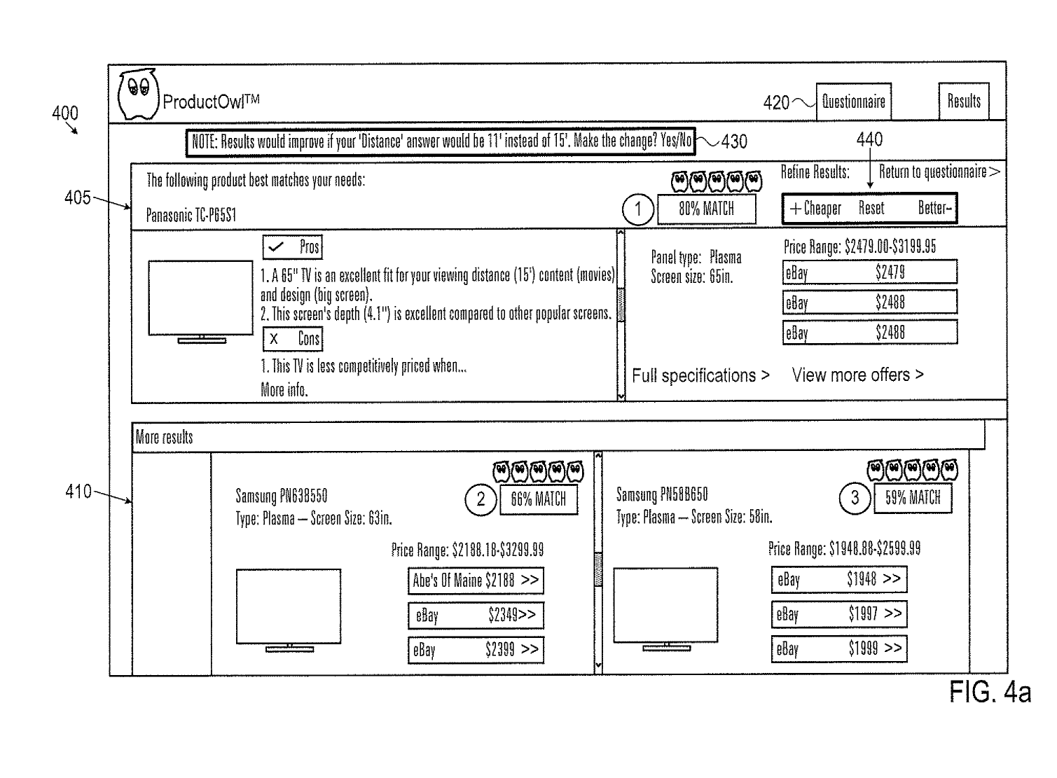

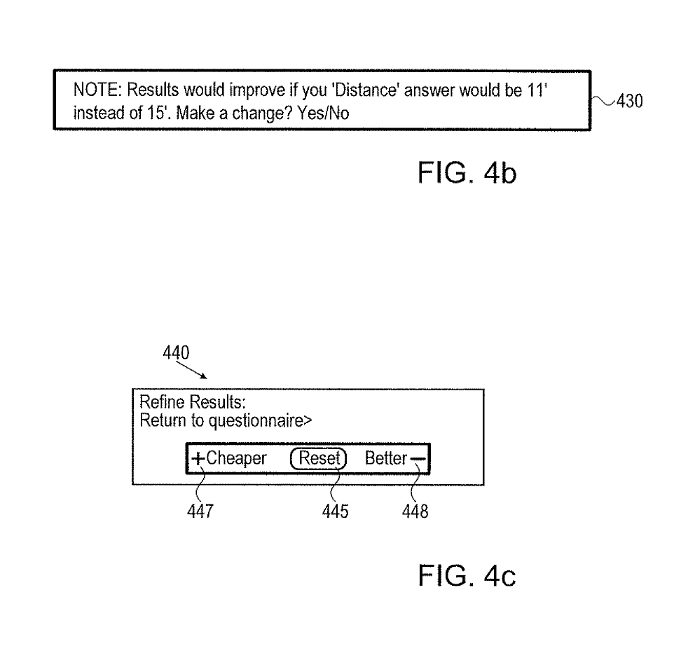

The Product Match Scoring Engine 210 is responsible for computing the match score of the available products given the initial answer set, or in light of a refined answer set, as shown in the results dialogue screen 400 of FIG. 4a. A best match recommendation 405 presents the best products fitting the consumer's needs, as is also demonstrated by an associated highest match rank, 80% in the example of FIG. 4a. Additional products, having a smaller match rank are shown in part 410.

Results screen 400 also includes a questionnaire tab 420 for enabling return to Questionnaire screen 300. In case of a return to screen 300, the answer set fed by the buyer previously appears on screen 300 and the buyer is able to modify certain answers at will. A “REFRESH” button may allow the buyer to have a fresh questionnaire and determines all the answers. However, besides having tab 420, the system avoids urging the buyer to return to screen 300. Actually, the system enables update of an answer set while interacting with the buyer on merely a single answer.

Screen 400 includes an alternative answer suggestion 430 with an approve/reject question, and a cost/benefit tradeoff box 440 which the buyer may navigate using the “Cheaper” and “Better” buttons or an arrow as elaborated below.

Engine 210 determines an inventory of suggested products and a product match score for each product in the inventory in accordance with Product Match Rules 211. A product match rule may be a filter rule determining whether the product should be allowed or rejected. For example, if a buyer answers a “budget” question with the range answer “200-$500”, a corresponding filter rule might reject all products outside this range. A product match rule may be a scoring rule determining the degree of product matching to consumer's needs as expressed in the answers to the questionnaire. Such product match rule determines to which extent the product matches one or more of the buyer's answers. For example, if a buyer answers a “Viewing Distance” question with “11 feet”, a corresponding numeric value rule might assign a low numeric value to TVs below 42 inches in size and a high numeric value to TVs between 50 and 60 inches in size, as these are considered the best fit for a viewing distance of 11 feet.

A product match rule may be dependent on more than one answer, where the answers may be a numeric value, a numeric range, free text or choice.

A weight is given to each rule score in accordance with the preferences expressed in the answers of the consumer. Thus, the product score is a weighted average of the rule scores. Also, engine 210 performs score normalization and/or scaling in order to lay different products on a comparable ground, to be expressed by a percent value, for example.

The Answer Refinement Manager 220 receives from Service 104 a filled questionnaire, or an initial answer set, the available products and a history of answer set refinements performed previously by the consumer. Manager 220 provides alternative refined answer sets, and for each alternative refined answer set it provides a respective matched product inventory and the scores of the products in the inventory. The matched product inventory is returned to Service 104 for display to the consumer. This routine may be repeated multiple times until the consumer is satisfied with the suggested products and/or places an order for a chosen product.

The process is exemplified in part in FIG. 4a, which shows an initial inventory of suggested products in parts 405 and 410 of screen 400, where each product has a score indicating its match to the initial answer set of the consumer. In the example, a TV set is the required product and the initial answer set indicated that the distance between the seating position and the TV set is 15′. Answer Refinement Manager 220 suggests several alternative answer sets. A first refined answer set is based on having a distance of 11′ instead of the distance of 15′. This refined answer set is suggested to the consumer by posting question 430 “Note: Results would improve if your ‘Distance’ answer would be 11′ instead of 15′. Make the change? YES/NO”. In case that the consumer presses “yes”, the first refined answer set replaces the initial answer set and the inventory of suggested products expressed in parts 405 and 410 of screen 400 is changed to account for 11′ distance of the first refined answer set (the changed inventory is not shown in FIG. 4a).

The Tradeoff Axis Manager 260 offers another method for improving product matches. The corresponding answer set refinement is presented to the consumer by tradeoff box 440, which in this example allows the consumer to move the arrow 445 to a desired position along an imaginary line or axis between the cheapest TV set and the best TV set, wherein “best” may be defined as a weighted average of the match of certain quality parameters like spatial resolution, size, and luminous intensity, to the buyer's answer set. The initial position fits the initial answer set or some default value, while moving to a new position yields a corresponding new inventory of suggested products, each with its matching score. As explained above, a product having a higher cost and lower benefit than another point is ignored, so every change done in the tradeoff box 440 results in either a lower cost or higher benefit.

The Answer Refinement Manager 220 uses Alternative Answer Set Generator 240 to generate alternative answer sets, as further described below. These alternative answer sets are delivered to the Change Evaluator 250, which computes for each alternative answer set a differential cost required for replacing the initial answer set by the alternative answer set. In this context “cost” relates to the likelihood that the shopper will be willing to accept an alternative answer set. Then, the Alternative Set Match Gain Calculator 230 calculates the gain an alternative answer set yields comparing to the initial answer set. The gain is calculated as the increase in the match of the best matching product using the alternative answer set compared to the match of the best matching product using the initial answer set. The Answer Refinement Manager 220 uses the gain and cost information to rank the alternative answer sets and returns the best alternative answer sets to the Consumer Product Recommendation Service 104 so that the consumer refines the initial answer set. The best alternative answer sets are those having the high gain and low cost—in other words, they provide a significant improvement in product match and require changes that the shopper is relatively likely to accept.

The Alternative Answer Set Generator 240 is responsible for generating alternative answer sets based on the initial answer set obtained by filling a questionnaire. The Alternative Answer Set Generator 240 uses different types of mutators 241,242,243 and 244 for answers to respective different types of questions 310,320, 330 and 340. A Single Choice Mutator 241 may replace a chosen choice with a different choice. For example, the initial answer set displayed in FIG. 3 includes placing a TV set on a stand. Mutator 241 may replace that choice with the hang option. Mutator 241 may have rules dictating that certain choices are changeable while other choices should remain as determined in the initial answer set.

A Multiple Choice Mutator 242 may replace or remove one or more choices and/or add more choices. Mutator 242 may have rules dictating the possible mutations. like the number of allowed changes. A Numeric Value Mutator 243 may change a value determined in the answer set with a different value. Mutator 243 may have an operating rules limiting the allowed changes like an allowed maximum change of a value. Similarly, a Numeric Range Mutator 244 may change one or more of the bounds in the current range as determined in the initial answer set with a different value. Mutator 244 may have operating rules limiting the allowed changes like an allowed maximum change of a bound. For all mutators, some questions may be marked to indicate that their values may not be changed. Other limits may include the number of changes.

In an example of a possible operation of a Mutator, a Multiple Choice Mutator 242 removes each choice made by the user, one at a time. The system then runs a new match calculation against the entire inventory and compares the new best matching TV's score to a baseline score, which is the score of the best matching TV using the initial answer set. The change that yielded the highest positive change is then suggested to the shopper. In case the shopper provided an initial answer set that was too limiting and no matches were found, the baseline score is considered to be zero and the Mutator goes through the same process.

Exemplary Mutator operating rule changes a budget-limits question, rather than suggesting the product brands preferred by the buyer. Other exemplary Mutator operating rules determine a size of the change for numeric value and numeric range, determine the percentage of the change for numeric value and numeric range questions, determine the number of changed answers for a multiple choices question, or determine whether an answer is added or removed.

The Change Evaluator 250 is used to give a numeric cost for the significance of the change incorporated in an alternative answer set. The Answer Cost Evaluator 251 is used to compute the cost of the change to a single question. The Answer Cost Evaluator 251 may take into account details such as the specific question and answer being changed, the number of choices changed for choice answers, the absolute or relative difference in numeric value answers, and the absolute or relative difference for the bounds in a numeric range answer. Calculating the cost from these changes may be done using formulas pre-configured manually by a system operator. Alternatively, it may be done automatically by tracking the portion of shoppers who agreed to a similar change in the past. The Answer Set Cost Evaluator 252 computes the cost of the entire alternative answer sets by considering the costs of the individual questions as computed by the Answer Cost Evaluator 251 and the overall effect of the alternative answer set such as the number of answers changed.

Similarly, the Alternative Set Match Gain Calculator 230 is responsible for computing for each alternative answer set the match gain associated with the proposed change from a basic answer set to the alternative answer set. The Alternative Set Match Gain Calculator 230 may use the Product Match Scoring Engine 210 to compute the gain as the difference in the resulting match score between a basic answer set and the alternative answer set.

The Tradeoff Axis Manager 260 is responsible for managing the tradeoff axis navigation process used to improve product recommendation by allowing the buyer to control the tradeoff between some answers in the answer set, while viewing the tradeoffs effect on the inventory of the recommended products. The Axis Discoverer 261 is used to identify tradeoff axes relevant to the buyer. New axes are calculated by identifying buyer answers that reflect rules of conflicting nature. An example of such answers are a “TV fit for playing video games” and “TV fit for a dark room” the first answer reflects an advantage for an LCD TV while the second answers reflects an advantage for a Plasma TV. The Axis Discoverer 261 can also have preconfigured tradeoff axes, e.g. a “Price” vs. “Benefit” axis.

An exemplary “Price” vs. “Benefit” tradeoff axis 440 is shown in FIGS. 4a and 4c. The consumer may displace an arrow 445 to the left hand side in order to determine high preference to an answer relating to low price, or move the arrow to the right hand side to determine a high preference to all other answers (i.e. preferring a better match to a low price).

The Axis Navigator 262 is responsible for improving the buyer's axis navigation effectiveness. The Axis Navigator 262 determines the points on the axis in which a different product recommendation will appear, and allow the buyer to navigate to these points directly. The Axis Navigator 262 also calculates when further advances on a specific axis direction is no longer relevant, as no further product recommendation changes would appear. In this case, the Axis Navigator 262 will alert the buyer that no further products exist on this axis direction.

In an example of the present invention a shopper provides the following answer set in response to the system's questionnaire:

Viewing distance: 10 ft,

Content: Movies, Sports, Web Browsing, Gaming.

Sound: Using internal speakers.

Connected devices: DVD, Media Streamer, Cable/Satellite, Gaming console.

Price: Up to $1400.

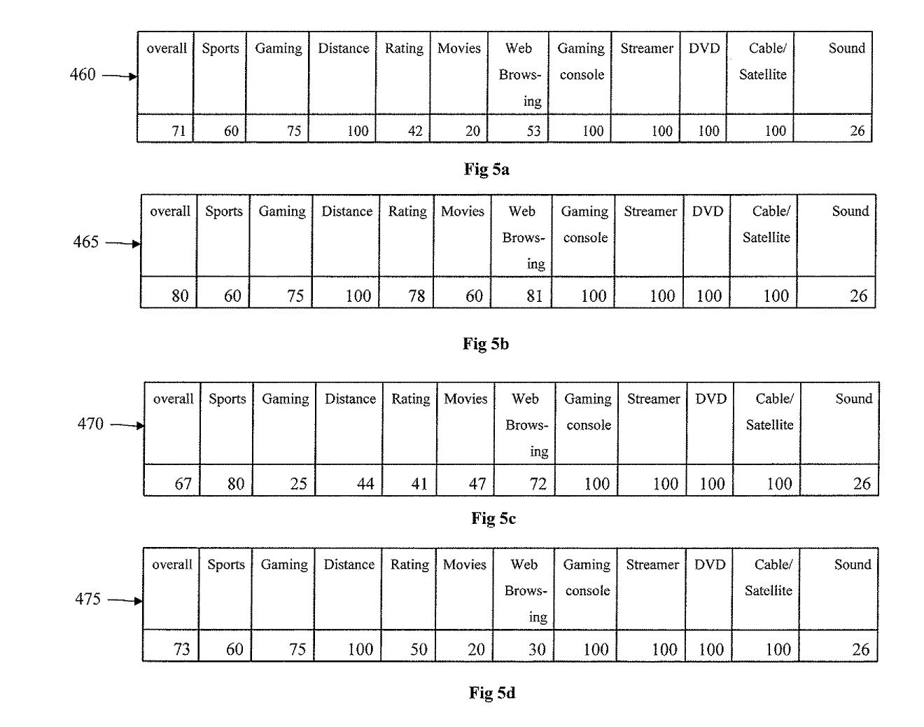

Given these parameters the system recommends a first TV set (Panasonic TCL55E50 55″ Smart Viera 1080p LED HDTV) which costs $1399 and matches the shopper's needs by 71%. The score is calculated from the quality scores shown in Table 460 of FIG. 5a. It should be noted that certain scores, like “rating”, do not reflect the answer set, but the outcome of product evaluation by experts.

Each Score is calculated by running a predetermined rule that takes the quality scores of each TV (which may have been given by product experts). The system assigns weights to each quality score, according to the answer set. In this example, a weight of 1 is assigned to requirements given by the shopper and 0 to the rest. Additionally, a distance score is assigned to each TV set as follows: 55 inch is the recommended TV size for the user's needs and preferences, any smaller or larger screens that do not pass a pre-defined threshold, are given lower scores for the distance factor. The overall match score is 71%, as shown in table 460 of FIG. 5a.

The system now offers three options to the shopper:

1—Use the “Better” option which shows a better match: a second TV set (LG 55LM6200 55″ 1080p LED LCD 3D HDTV) with 80% match at a higher price point of $1499, as shown in table 465 of FIG. 5b. By choosing this option the shopper indicates his flexibility with the price constraint given earlier ($1400).

2—Use a “Cheaper” option which will lead to a third TV set (LG 60PM6700 60″ Plasma 3D Smart TV) that has 67% match to the user's needs at a price of $1299, as shown in table 470 of FIG. 5c.

3—Alter one of the parameters in the answer set. The Alternative Answer Set Generator 240 generates alternative answer sets using Mutators 241, 242, 243, 244 and searches for an answer in the answer set that if changed can significantly improve the match score, while having a low ‘cost of change’ as evaluated by Change Evaluator 250. The system then presents the suggested change to the shopper. For example, the system may recommend removing from the parameter “Content” the value “Web Browsing”, which currently triggers a rule that gives a weight of 1 to the “Web Browsing” score of televisions, resulting in higher priority for TVs with better web browsing compared to those with a less sophisticated browser or no browser at all. By presenting this option, the system states to the shopper that the “Web Browsing” requirement limits the system's ability to comply with the shopper's other requirements. If the shopper decides that “Web Browsing” is a crucial requirement he rejects the system's suggestion, and may be presented with another alternative refined answer set. If the shopper decides to accept the suggestion, the system changes the initial answer set accordingly, restarting the process using this refined answer set. In this case the refined answer set results in a recommendation of a fourth TV set (LG 55LS5700 55″ Smart LED TV) that has a score of 73% at a price of $1399, just like the first TV set but with a better overall match, as shown in table 475 of FIG. 5d. Note that in this case the “Web Browsing” score is ignored and is not calculated in the overall score.

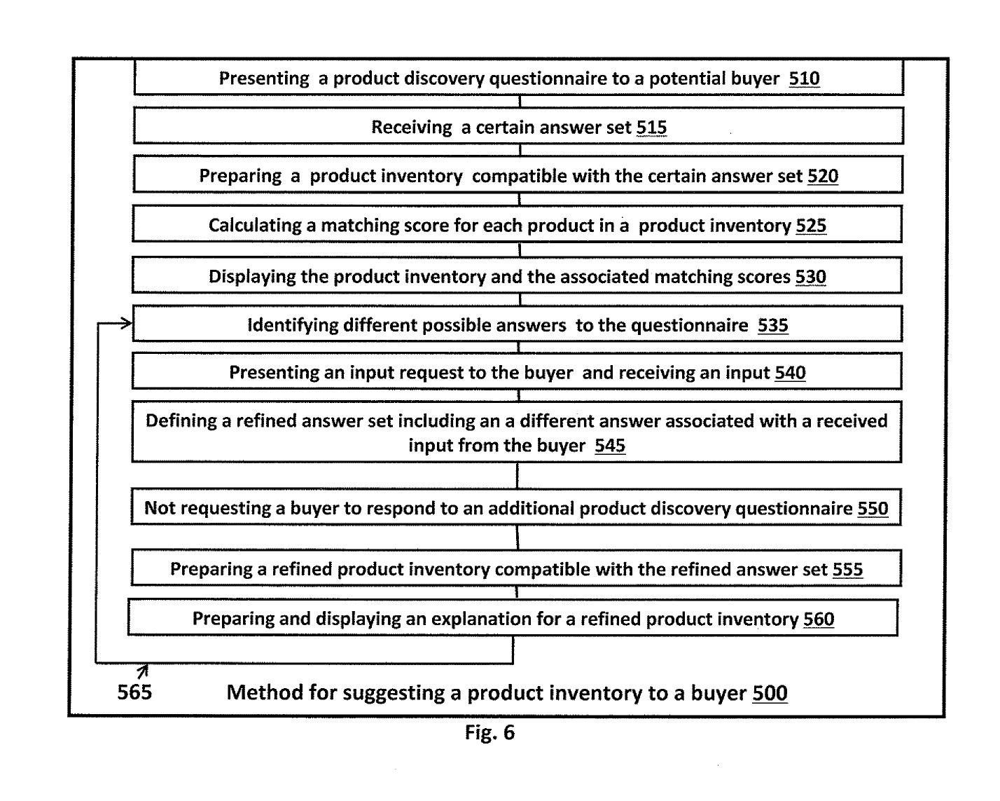

Reference is now made to FIG. 6 which presents a method 500 for suggesting a product inventory to a buyer. Method 500 includes a step 510 of presenting a product discovery questionnaire to a potential buyer, a step 515 of receiving a certain answer set, a step 520 of preparing a product inventory compatible with the certain answer set, a step 525 of calculating a matching score for each product in the product inventory, and a step 530 of displaying the product inventory and the associated product matching scores.

Method 500 further includes a step 535 of identifying different answer to the questionnaire, a step 540 of presenting an input request to the buyer and receiving the input, a step 545 of defining a refined answer set which includes a different answer associated with the received input from the buyer, a step 550 of not requesting the buyer to respond to an additional product discovery questionnaire.

In addition, method 500 includes a step 555 of preparing a refined product inventory compatible with the refined answer set, a step 560 of preparing and displaying an explanation to a refined product inventory, and a step 565 of repeating steps 535,540,545,550, 555 and 560 while still needed, where a refined answer set becomes the basis answer set for that process. Once the buyer places an order for the product, the process ends. Alternatively, the system may find out that no further improvement of the suggested inventory is possible, and thus it discontinues the process.

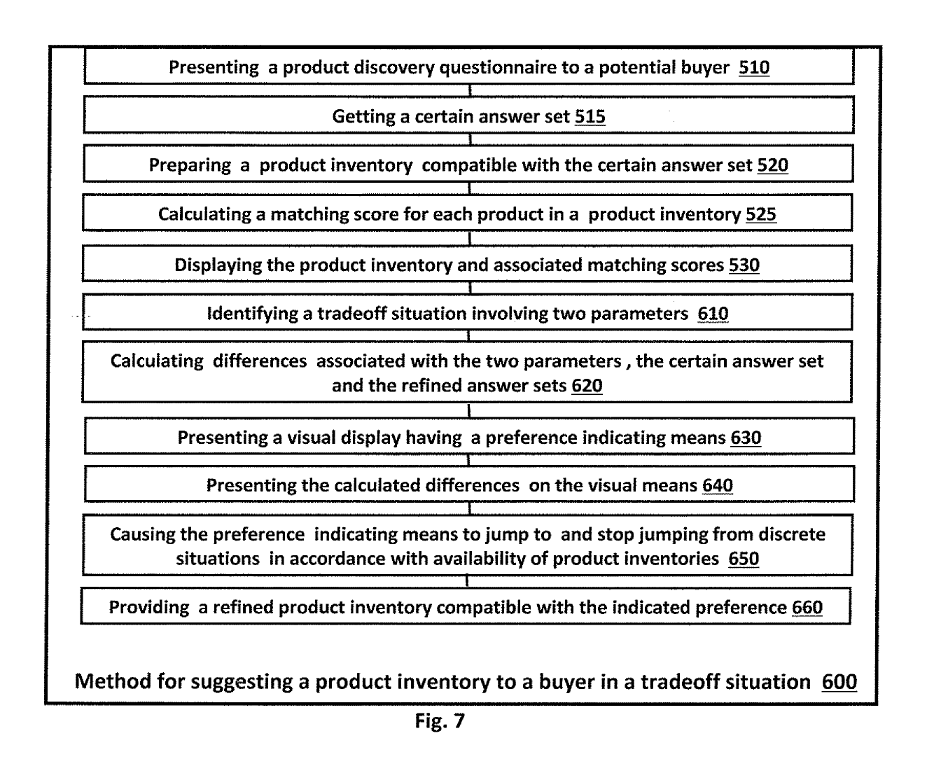

FIG. 7 presents a flow chart of a method 600 for suggesting a product inventory to a buyer in a tradeoff situation. Method 600 includes a step 610 of identifying a tradeoff situation involving two parameters, a step 620 of calculating differences associated with the two parameters, whereas a difference of a parameter is between a parameter value corresponding the certain answer set and a parameter value corresponding to the refined answer set.

Method 600 further includes a step 630 of presenting a visual display having a preference indicating means for allowing the buyer to express preference between the two parameters. In one embodiment the preference indicating means is an arrow 445 slidable along a line connecting the cheapest but least matching product with the best but most expensive product. In another embodiment, buttons 447 and 448 are available for affecting the tradeoff situation.

Method 600 also includes a step 640 of presenting the calculated differences on the visual means, a step 650 of causing the preference indicating means to jump to and stop jumping from discrete situations in accordance with availability of product inventories, and a step of providing a refined inventory compatible with the indicated preference.

Other aspects would become apparent to those skilled in the relevant art(s) in view of the teachings of the present disclosure. The drawings are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (i.e., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by a processor to cause the processor to perform the functions of the invention as described herein. In this document, the terms “machine readable medium,” “computer program medium” and “computer usable medium” are used to generally refer to media such as a removable storage unit (e.g., a magnetic or optical disc, flash ROM, or the like), a hard disk, signals (i.e., electronic, electromagnetic, or optical signals), or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A computer-implemented method for suggesting an inventory of one or more matched products to a potential buyer of a product after getting a certain answer set provided by the buyer in a response to a respective product discovery questionnaire, the method comprising:
(a) identifying at least one answer different from the respective answer in the certain answer set, the at least one different answer and the respective answer being both possible answers to the same question in the product discovery questionnaire;
(b) presenting to the buyer at least one input request associated with said at least one different answer;
(c) defining at least one refined answer set in accordance with at least one input provided by said buyer in response to said at least one input request, said refined answer set including said at least one different answer; and
(d) preparing at least one refined inventory of one or more matched products in accordance with said at least one refined answer set,
wherein said at least one refined inventory being presented to said buyer, thus facilitating placement of an order for a product of said refined inventory.

2. The method of claim 1 wherein said at least one different answer is identified as having a chance to be acceptable by the buyer.

3. The method of claim 1 wherein said method includes a step of not requesting a buyer to respond to a product discovery questionnaire in addition to the product discovery questionnaire the buyer had already responded to.

4. The method of claim 1 wherein the method includes a step of selecting a different answer from a group of different answers consisting of a different answer to a single choice question, a different answer to a multiple choice question, a different answer to a numeric value question and a different answer to a number range question.

5. The method of claim 1 wherein the method includes a step of presenting an inventory of one or more matched products compatible with an answer set.

6. The method of claim 5 further includes a step of displaying an explanation in association with presenting an inventory of one or more matched products compatible with a refined answer set, the explanation comprises at least one item from a group of items consisting of an identification of an answer in said refined answer set different from a respective answer in said certain answer set, and a description of the improvement done in moving from said certain inventory to said refined answer set.

7. The method of claim 5 wherein the method includes:
(i) calculating a matching score for each product of an inventory of one or more matching products, said matching score reflecting the compatibility of said product with said answer set;
(ii) displaying said matching score in association with the respective product.

8. The method of claim 7 wherein a refined inventory of one or more matched products includes at least one product having a higher matching score than any of the products of an inventory of one or more matched products associated with said certain answer set.

9. The method of claim 7 wherein said matching score is calculated in accordance with a set of matching rules, and at least one matching rule is a filter rule determining whether a product is accepted or rejected, or a numeric value rule contributing a calculated numeric value to the product matching score in accordance with the extent a product matches at least one answer of said answer set.

10. The method of claim 7 wherein the method includes:
(i) preparing two or more refined inventories of matched products in accordance with two or more respective refined answer sets;
(ii) calculating two or more respective inventory matching scores for the two or more respective refined answer sets, each inventory matching score being a normalized sum of matching scores of at least a fixed top relative part of the matching products in the inventory;
(ii) presenting the inventories and the associated inventory matching scores to the buyer.

11. The method of claim 1 further includes a step of repeating the steps of the method starting with identifying a different answer, a refined answer set serving as a certain answer set.

12. The method of claim 11 wherein said repeating continues until at least one event of a group of events occurs, the group of events consisting of placement of an order for the product, and finding out that no better refined answer set is available.

13. The method of claim 1 wherein the method includes a step of presenting the buyer a certain product discovery questionnaire comprising a plurality of questions, and presenting for each question of at least a major portion of the plurality of questions one or more possible answers such as to allow the buyer to provide said certain answer set.

14. The method of claim 13 wherein at least one question of said plurality of questions is selected from a group of questions consisting of a question requiring a single choice answer, a question allowing multiple choice answers, a question requiring a numeric value answer, a question requiring a numeric range answer, and a question requiring a free text answer.

15. A computer-implemented method for suggesting an inventory of one or more matched products to a potential buyer of a product after getting a certain answer set provided by the buyer in a response to a product discovery questionnaire, a trade off situation being exist between at least two parameters, a first parameter of the product and a second parameter of the product, such that an increase in one parameter of the product occurs substantially together with a decrease of the at least one other parameter of the product, the method comprising:
(a) presenting a visual display showing the tradeoff situation between the two parameters, said visual display including an indicating means for allowing said buyer to indicate a preference of one parameter relative to at least one other parameter; and
(b) providing an inventory of one or more matched products associated with a refined answer set compatible with the indicated preference.

16. The method of claim 15 wherein the method includes a step of calculating a first difference and a second difference associated respectively with said first parameter and said second parameter, a parameter difference is between a parameter value attributed to said refined answer set and a parameter value attributed to said certain answer set.

17. The method of claim 16 wherein the method further includes a step of presenting said first difference and said second difference, thus facilitating a quantitative analysis of said tradeoff situation.

18. The method of claim 15 wherein one of the two parameters is selected from a group of parameters consisting of a parameter predetermined by a system implementing the method, a parameter determined by an analysis of an answer set, a price of the product, a matching score reflecting the matching of a product to at least a portion of an associated answer set, a number of matching products in an inventory of matched products compatible with an associated answer set, a sum of matching scores of at least a fixed top relative part of the matching products in an inventory of matched products compatible with an associated answer set, and a normalized sum thereof.

19. The method of claim 15 wherein the method further includes a step of presenting an updated inventory of one or more matched products simultaneously with determining a preference indication by said buyer.

20. The method of claim 19 wherein said indicating means is an indicator free to move along a segment, and said method includes:
(A) causing said indicator to jump in a direction determined by said buyer in accordance with the availability of inventories compatible with the indicated preference; and
(B) disabling indicator movement in a direction once no products are available in said direction.

21. The method of claim 15 wherein the method includes a step of identifying the existence of the trade off situation between the two parameters.
